(19) United States
(12) Patent Application Publication
(10) Pub. No.: US 2010/0160458 A1
(43) Pub. Date: Jun. 24, 2010

(54) METHOD OF MAKING A COMPOSITION AND AQUEOUS COMPOSITION PREPARABLE THEREBY

(75) Inventors: Patricia M. Savu, Maplewood, MN (US); Philip G. Clark, Eden Prairie, MN (US); Michael J. Parent, Davenport, IA (US); Jason M. Kehren, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/625,652

(22) Filed: Nov. 25, 2009

Related U.S. Application Data
(60) Provisional application No. 61/140,108, filed on Dec. 23, 2008.

(51) Int. Cl. B01F 17/26

(52) U.S. Cl. 516/9

(57) ABSTRACT

A method of making a composition comprises independently providing a first component comprising a first compound, and a second components comprising a second compound; and combining the first component and the second component, wherein:
a) the first compound is represented by

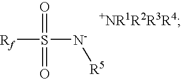

and
b) the second compound is represented by

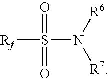

R_{f} represents a perfluoroalkyl group having from 1 to 12 carbon atoms. R¹, R², R³, and R⁴ each independently represent H or an alkyl group having from 1 to 6 carbon atoms. R⁵ represents H, an alkyl group having from 1 to 6 carbon atoms, or a hydroxyalkyl group having from 1 to 6 carbon atoms. R⁶ and R⁷ each independently represent an alkyl group having from 1 to 6 carbon atoms, or a hydroxyalkyl group having from 1 to 6 carbon atoms. Compositions preparable according to the method are also disclosed.

### CROSS-REFERENCE TO RELATED APPLICATION

This application claims the benefit of U.S. Provisional Patent Application No. 61/140,108, filed Dec. 23, 2008, the disclosure of which is incorporated by reference herein in its entirety.

### TECHNICAL FIELD

The present disclosure relates broadly to methods of making the aqueous compositions and aqueous compositions preparable by the methods.

### BACKGROUND

Surfactants are commonly included in aqueous compositions to reduce surface tension and improve wetting performance of the composition. Surfactants can be classified by type; for example, anionic, cationic, nonionic, or zwitterionic. Certain fluorinated compounds are widely used as surfactants in aqueous and non-aqueous compositions.

Chemical reactions such as those used to prepare surfactants frequently result in crude reaction products that contain various components such as, for example, unreacted starting materials, isomers, and side products. An example is illustrated by the following reaction scheme, corresponding to the disclosure in col. 7, lines 29-63 of U.S. Pat. No. 7,169,323 (Parent et al.).

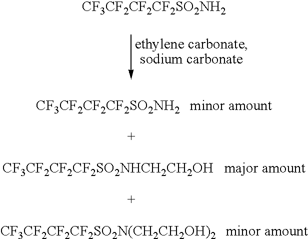

wherein hydroxyalkylation of nonafluorobutylsulfonamide in the presence of ethylene carbonate and sodium carbonate results in a mixture containing a major amount of the monoadduct CF₃CF₂CF₂CF₂SO₂NHCH₂CH₂OH, and minor amounts of unreacted starting material CF₃CF₂CF₂CF₂SO₂NH₂ and the diadduct CF₃CF₂CF₂CF₂SO₂N(CH₂CH₂OH)₂. Typically, purification is carried out to enrich the amount of, or isolate, a desired product before subsequent use, although it is also known to use reaction mixtures without purification for some applications. Some fluorinated sulfonamides such as, for example, CF₃CF₂CF₂CF₂SO₂NHCH₂CH₂OH and CF₃CF₂CF₂CF₂SO₂NH₂ can be readily deprotonated to form anionic surfactants (e.g., using aqueous ammonium hydroxide). If not sufficiently alkaline, aqueous solutions of such fluorinated surfactants may contain a mixture of significant amounts of neutral and anionic forms of the fluorinated surfactants.

### SUMMARY

Applicants presently disclose that, in at least some cases, surface tension may be reduced beyond that achieved by fluorinated anionic surfactants alone by combining a fluorinated anionic surfactant with a fluorinated nonionic surfactant.

Accordingly, in one aspect, the present disclosure provides a method of making a composition, the method comprising:

independently providing a first component comprising a first compound, and a second component comprising a second compound; and

combining the first component and the second component,

wherein:
a) the first compound is represented by

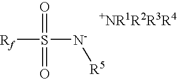

wherein
   R_{f} represents a perfluoroalkyl group having from 1 to 12 carbon atoms;
   R¹, R², R³, and R⁴ each independently represent H or an alkyl group having from 1 to 6 carbon atoms; and
   R⁵ represents H, an alkyl group having from 1 to 6 carbon atoms, or a hydroxyalkyl group having from 1 to 6 carbon atoms; and
b) the second compound is represented by

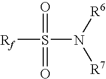

wherein
   R⁶ and R⁷ each independently represent an alkyl group having from 1 to 6 carbon atoms, or a hydroxyalkyl group having from 1 to 6 carbon atoms.

In some embodiments, at least one of the first component or the second component further comprises water. In some embodiments, the method further comprises adding water to the composition. In some embodiments, a relative mole ratio the first compound to the second compound is in a range of from 1:1 to 20:1. In some embodiments, all of R¹, R², R³, and R⁴ are H or all of R¹, R², R³, and R⁴ are methyl. In some embodiments, R⁵, R⁶, and R⁷ are hydroxyalkyl groups. In some embodiments, R⁶ and R⁷ are the same and all of R¹, R², R³, and R⁴ are methyl. In some embodiments, the method further comprises adding a third compound to the composition, the third compound represented by

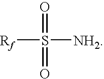

In another aspect, the present disclosure provides an aqueous composition comprising:

water;

a first compound represented by

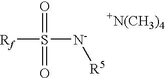

wherein
   R_{f} represents a perfluoroalkyl group having from 1 to 12 carbon atoms; and
   R⁵ represents H, an alkyl group having from 1 to 6 carbon atoms, or a hydroxyalkyl group having from 1 to 6 carbon atoms; and

a second compound represented by

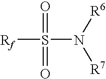

wherein
   R⁶ and R⁷ each independently represent an alkyl group having from 1 to 6 carbon atoms, or a hydroxyalkyl group having from 1 to 6 carbon atoms, and

wherein the aqueous composition is essentially free of halide ions.

In some embodiments, a relative mole ratio of the first compound to the second compound is in a range of from 1:1 to 20:1. In some embodiments, the first compound and the second compound collectively comprise at least 5 percent by weight of the aqueous composition. In some embodiments, the first compound and the second compound are collectively present in the aqueous composition in an amount of from 100 to 10,000 parts per million by weight of the aqueous composition. In some embodiments, each of R⁵, R⁶, and R⁷ are 2-hydroxyethyl groups.

In some embodiments, the first compound is selected from the groups consisting of ammonium N-perfluorobutanesulfonamide, ammonium N-perfluoro-(2-hydroxyethyl)perfluorobutanesulfonamide, tetramethylammonium N-perfluorobutanesulfonamide, and tetramethylammonium N-perfluoro-(2-hydroxyethyl)perfluorobutanesulfonamide. In some embodiments, the second compound is selected from the groups consisting of N,N-bis(2-hydroxyethyl)perfluorobutanesulfonamide and N-methyl-N-(2-hydroxyethyl)perfluorobutanesulfonamide. In some embodiments, R_{f} has from 3 to 5 carbon atoms.

As used herein:

the term “deionized water” refers to water having electrical resistance of at least 10 megohm-centimeter;

the term “essentially free of halide ions” means containing not more than 100 parts per million of all halide ions (i.e., fluoride, chloride, bromide, iodide, and astatide) combined;

the term “perfluoroalkyl group” refers to a fully fluorinated alkyl group such as, for example, CF₃—, CF₃CF₂—, CF₃CF₂CF₂—, (CF₃)₂CFCF₂CF(CF₃)CF₂—, or CF₃CF(CF₂CF₃)CF₂CF(CF₃)CF₂—.

In this application, whenever the presence of an ionic salt is indicated its presence is based on stoichiometric equivalent amounts of cationic and anionic constituent parts, which constituent parts may be present in dissociated or associated form.

### DETAILED DESCRIPTION

Compositions prepared according to the present disclosure include a first compound that is represented by the formula:

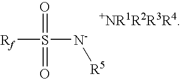

R_{f} represents a perfluoroalkyl group having from 1 to 12 carbon atoms. Examples include perfluorooctyl, perfluorododecyl, perfluorodecyl, perfluorohexyl, perfluoropentyl, and perfluorobutyl groups. Typically, R_{f} has from 3 to 5 carbon atoms. More typically, R_{f} is a perfluorobutyl group. R_{f} may be linear or branched, and may be cyclic or acyclic.

R¹, R², R³, and R⁴ each independently represent H, or an alkyl group having from 1 to 6 carbon atoms. Exemplary groups R¹ to R⁴ include methyl, ethyl, propyl (e.g., 2-propyl or 1-propyl), butyl (e.g., 2-butyl or 1-butyl), pentyl, and hexyl groups.

R⁵ represents H, an alkyl group having from 1 to 6 carbon atoms, or a hydroxyalkyl group having from 1 to 6 carbon atoms. Exemplary alkyl groups R⁵ include methyl, ethyl, propyl (e.g., 2-propyl or 1-propyl), butyl (e.g., 2-butyl or 1-butyl), pentyl, and hexyl groups. Exemplary hydroxyalkyl groups R⁵ include hydroxymethyl, 2-hydroxyethyl, 3-hydroxypropyl, 3-hydroxybutyl, 4-hydroxybutyl, 5-hydroxypentyl, and 6-hydroxyhexyl groups.

Compositions prepared according to the present disclosure include a second compound that is represented by the formula:

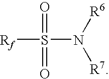

R_{f} is as previously defined.

R⁶ and R⁷ each independently represent an alkyl group having from 1 to 6 carbon atoms, or hydroxyalkyl groups having from 1 to 6 carbon atoms. Exemplary alkyl groups having from 1 to 6 carbon atoms include methyl, ethyl, propyl (e.g., 2-propyl or 1-propyl), butyl (e.g., 2-butyl or 1-butyl), pentyl, and hexyl groups. Exemplary hydroxyalkyl groups having from 1 to 6 carbon atoms include hydroxymethyl, 2-hydroxyethyl, 3-hydroxypropyl, 3-hydroxybutyl, 4-hydroxybutyl, 5-hydroxypentyl, and 6-hydroxyhexyl groups. R⁶ and R⁷ may be the same or different.

Any amount of the first and second compounds may be used. However, typically small quantities of the first and second compounds are sufficient to substantially reduce the surface tension of the composition. Typically, concentrations of the first and second compositions taken together in a range of from 100 to 10000 parts per million by weight (e.g., in a range of from 200 to 5000 parts per million by weight) are effective to provide good wetting properties, although this is not a requirement. Alternatively, the composition may be provided in a concentrated form; for example, the first and second compounds may collectively comprise at least 5, 10, 15, 20, or even at least 25 percent by weight of the composition which may be diluted to concentrations of the first and second compositions taken together in a range of from 100 to 5000 parts per million.

Any relative amounts of the first and second compounds may be used. Typically, a respective mole ratio of the first compound to the second compound in a range of from 1:1 to 20:1, more typically 2:1 to 10:1, is effective for use as a surfactant.

The first and second compounds may be prepared according to procedures known to those in the fluorochemical arts; for example, analogously to the procedures in U.S. Pat. No. 7,169,323 (Parent et al.).

In some embodiments, compositions prepared according to the present disclosure comprise aqueous compositions. Aqueous compositions according to the present disclosure are first of all aqueous; that is they comprise substantial amounts of water. Typically, they comprise at least 20 percent by weight of water. More typically, they comprise at least 30, 40, 50, 60, 70, 80, 90, 99, or even at least 99.9 percent by weight of water, or more. Water-soluble organic solvents may be included in aqueous compositions according to the present disclosure; for example, in aqueous compositions having relatively lower water content. The remaining components of the aqueous compositions are typically dissolved or dispersed in the water and optional water-soluble organic solvent. Exemplary water-soluble organic solvents include ethers (e.g., tetrahydrofuran, p-dioxane, or diglyme), ketones (e.g., acetone), alcohols (e.g., methanol, ethanol, or isopropanol), and combinations thereof.

Aqueous compositions according to the present disclosure may be essentially free of halide ions. This is typically desirable for applications in electronics.

Aqueous compositions according to the present disclosure may comprise additional non-halide components; however, those aqueous compositions that consist essentially of water, the first compound and the second compound are useful as aqueous rinses (i.e., without need for added optional components). Accordingly, the aqueous compositions may be used to rinse a surface of a substrate, which may comprise a chemically etched surface or an exposed and/or developed photoresist. Examples of substrates include glass, polysilicon, and metal (e.g., copper or aluminum). Aqueous compositions according to the present disclosure, when appropriately diluted are useful as a rinse for etched silicon wafers, or exposed and/or developed photoresists on silicon wafers, during semiconductor device fabrication, especially because they typically exhibit low surface tension at dilute concentration due to their low surface tension and extremely low halide ion content (especially fluoride).

Typically, the pH of aqueous compositions according to the present disclosure is such that the first compound (i.e., fluorinated alkylsulfonamide) exists largely in the anionic form (as opposed to it corresponding neutral form). For example, in some embodiments the pH may be at least 8, 9, 10, or even higher.

Objects and advantages of this disclosure are further illustrated by the following non-limiting examples, but the particular materials and amounts thereof recited in these examples, as well as other conditions and, details, should not be construed to unduly limit this disclosure.

### Examples

Unless otherwise noted, all parts, percentages, ratios, etc. in the Examples and the rest of the specification are by weight.

In the Examples, “centimeters” are abbreviated as “cm”, and “grams” are abbreviated as “g”.

In the Examples, surface tensions were measured according to the method described in U.S. Pat. No. 7,169,323 (Parent et al.) at column 7, line 10.

### Preparation of CF₃CF₂CF₂CF₂SO₂NH₂ (HFBSA)

CF₃CF₂CF₂CF₂SO₂NH₂ was prepared according to the procedure of U.S. Pat. No. 7,169,323 (Parent et al.) at column 7, line 65.

### Preparation of CF₃CF₂CF₂CF₂SO₂N(CH₃)H (MeFBSA)

CF₃CF₂CF₂CF₂SO₂N(CH₃)H was prepared according to the procedure of U.S. Pat. No. 6,852,781 (Savu et al.) at column 21, line 16.

### Preparation of CF₃CF₂CF₂CF₂SO₂NHCH₂CH₂OH (HFBSE)

CF₃CF₂CF₂CF₂SO₂NHCH₂CH₂OH was prepared according to the procedure of U.S. Pat. No. 7,169,323 (Parent et al.) at column 7, line 29.

### Preparation of CF₃CF₂CF₂CF₂SO₂N(CH₃)CH₂CH₂OH (MeFBSE)

CF₃CF₂CF₂CF₂SO₂N(CH₃)CH₂CH₂OH was prepared according to the procedure of U.S. Pat. No. 6,852,781 (Savu et al.) at column 22, line 55.

### Preparation of CF₃CF₂CF₂CF₂SO₂N(CH₂CH₂OH)₂ (FBSEE)

In a one-liter flask fitted with a heating source, thermocouple, outlet port, and reflux condense, the amide FBSA (200 g distilled C₄F₉SO₂NH₂), sodium carbonate (7.1 g powdered sodium carbonate), and 25 g of ethylene carbonate were mixed together. The set point was 85° C. At 80° C. it was possible to start stirring the mixture. The set point was raised to 120° C. After 30 minutes, the second ethylene carbonate charge (25 g) was added, and the set point raised to 140° C. After 5.5 hours the addition of the ethylene carbonate charge was completed of a total of 125 g. The reaction mixture was heated at 140° C. for an addition 2 hours, then cooled to 89° C., and phosphoric acid solution (13 g of phosphoric acid dissolved in 143 ml water) was added slowly to maintain temperature above 85° C. A water phase formed which had a pH of 7. The (upper) water phase was separated from the lower product phase and discarded. Water (100 ml) was added at a sufficient rate to maintain the temperature above 80° C. Again, the (upper) water phase was separated from the lower product phase and discarded. Water (100 g) containing 10 g of sodium chloride was added and stirred with the lower product phase. The mixture was allowed to separate and the upper water phase was separated off and discarded. At 85° C., 10 mm of Hg (34 kPa) vacuum was pulled on the molten batch (lower phase remaining in the flask). The vacuum was pulled down slowly to maintain temperature and keep the batch from rocking up, and 10 mm Hg (34 kPa) of vacuum and 85° C. was maintained for one hour. At the end of this time air was admitted and the batch poured into a jar and weighed. A total of 236 g was isolated, which was distilled at 1-1 5 mm Hg (3-5 kPa) with a head temperature of 158-162° C. and a pot temperature of 175-182° C. to give 194 g of a white solid with a melting point of 77° C.

### Examples 1-11 and Comparative Examples A-C

Aqueous compositions were prepared as described below by combining the indicated compounds under alkaline conditions.

Separate stock solutions (100 grams each) of FBSA and FBSE were prepared at 25 percent solids as follows:

H-FBSA (25 g) and H-FBSE (25 g) were melted at about 80° C. and separately added to a mixture of water and ammonium hydroxide in a 2.6:1 molar ratio (water:ammonium hydroxide) (i.e., excess ammonium hydroxide was used relative to the sulfonamides, leading to deprotonation) to make 100 g of respective Stock Solutions I and II.

Stock Solutions I and II were then individually combined with solid FBSEE as reported in Table 1 and shaken until dissolved. The resultant mixtures/solutions each contained 2.0 g of total solids (anionic components plus diol), and were diluted to 2 percent by addition of the appropriate amount of distilled water to make 100 g of total solution. This solution was further diluted with water to make a 0.2 percent solution (2000 parts per million by weight (ppm)). Surface tensions were then measured as described above and are reported in Table 1 (below).

TABLE 1

| | | | | | | | | SURFACE |
|---|---|---|---|---|---|---|---|---|
| | | | | | | | | TENSION |
| | | | | | | | | IN WATER |
| | STOCK | STOCK | | WEIGHT RATIO OF | | | | AT 2000 PPM |
| | SOLUTION | SOLUTION | FBSEE, | COMPONENTS | | | | SOLIDS, |
| EXAMPLE | I, grams | II, grams | grams | HFBSA | HFBSE | FBSEE | REPLICATE | dyne-cm |
| Comparative | 0 | 8 | 0 | 0 | 1 | 0 | 1 | 50.88 |
| Example A | | | | | | | 2 | 61.77 |
| 1 | 0 | 7.6 | 0.1 | 0 | 0.95 | 0.05 | 1 | 41.4 |
| | | | | | | | 2 | 45.27 |
| 2 | 0 | 7.2 | 0.2 | 0 | 0.9 | 0.1 | 1 | 43.27 |
| | | | | | | | 2 | 43.61 |
| Comparative | 0.40 | 7.6 | 0 | 0.05 | 0.95 | 0 | 1 | 54.24 |
| Example B | | | | | | | 2 | 54.92 |
| 3 | 0.20 | 7.6 | 0.05 | 0.025 | 0.95 | 0.025 | 1 | 40.20 |
| | | | | | | | 2 | 43.46 |
| 4 | 0.20 | 7.2 | 0.15 | 0.025 | 0.9 | 0.075 | 1 | 36.44 |
| | | | | | | | 2 | 34.94 |
| 5 | 0.40 | 7.2 | 0.1 | 0.05 | 0.9 | 0.05 | 1 | 37.56 |
| | | | | | | | 2 | 42.12 |
| 6 | 0.40 | 6.8 | 0.2 | 0.05 | 0.85 | 0.1 | 1 | 35.74 |
| | | | | | | | 2 | 36.36 |
| 7 | 0.59 | 7.2 | 0.05 | 0.075 | 0.9 | 0.025 | 1 | 39.73 |
| | | | | | | | 2 | 43.28 |
| 8 | 0.59 | 6.8 | 0.15 | 0.075 | 0.85 | 0.075 | 1 | 37.66 |
| | | | | | | | 2 | 38.33 |
| Comparative | 0.78 | 7.2 | 0 | 0.1 | 0.9 | 0 | 1 | 48.47 |
| Example C | | | | | | | 2 | 58.37 |
| 9 | 0.78 | 6.8 | 0.1 | 0.1 | 0.85 | 0.05 | 1 | 36.42 |
| | | | | | | | 2 | 38.04 |
| 10 | 0.78 | 6.4 | 0.2 | 0.1 | 0.8 | 0.1 | 1 | 39.31 |
| | | | | | | | 2 | 40.25 |
| 11 | 0.34 | 5.93 | 0.44 | 0.039 | 0.741 | 0.22 | 1 | 25.99 |
| | | | | | | | 2 | 25.20 |

### Examples 12-15

Solutions were prepared by combining the amount of ammonium hydroxide (30 percent by weight) or tetramethylammonium hydroxide (25 percent by weight) indicated in Table 3 with sufficient deionized water to make 60 g base solutions. Fluorochemical components reported in Table 3 were melted in an oven at 90°, then added to the base solutions and shaken until the solids had dissolved to give a total of 80 g of stock solutions at 25 percent solids. These 25 percent stock solutions were then diluted with distilled water to a total fluorochemical concentration of 2000 ppm, and the surface tensions were measured and are reported in Table 2.

In Table 2 (below), “25% TMAH” means 25 percent by weight tetramethylammonium hydroxide; “30% AH” means 30 percent by weight ammonium hydroxide; and “2000 ppm” means at a concentration of 2000 parts per million by weight.

TABLE 2

| | | | | | | | SURFACE |
|---|---|---|---|---|---|---|---|
| | | | | | | | TENSION IN |
| | RELATIVE AMOUNTS OF | | | | | | DEIONIZED |
| | FLUOROCHEMICAL | | | | | | WATER AT |
| | COMPONENTS BY WEIGHT | | | | 25% | 30% | 2000 PPM, |
| EXAMPLE | HFBSA | HFBSE | FBSEE | MeFBSE | TMAH, g | AH, g | dynes/cm |
| 12 | 0 | 80 | 0 | 20 | 0 | 2 | 22.61 |
| 13 | 4.9 | 92.6 | 0 | 2.5 | 0 | 2.4 | 23.55 |
| 14 | 4 | 79 | 17 | 0 | 9.27 | 0 | 16.5 |
| 15 | 4 | 79 | 17 | 0 | 17.7 | 0 | 26.2 |

### Examples 16-17 and Comparative Example D

H-FBSA (1.04 g) and H-FBSE (24.3 g) were melted at about 80° C. and added to a mixture of water and ammonium hydroxide in a 2.6:1 molar ratio (water:ammonium hydroxide) (i.e., excess ammonium hydroxide was used relative to the sulfonamides, leading to deprotonation) to make 100 g of Stock Solution III.

Stock Solution III was then combined with solid FBSEE as described in Examples 1 to 11 and shaken until dissolved. The resultant mixtures/solutions each contained 2.0 g of total solids (anionic components plus diol), and were diluted to 2 percent by addition of the appropriate amount of distilled water to make 100 g of total solution. The 2000 parts per million by weight (ppm) solutions whose surface tensions are reported in Table 3 (below) were prepared by taking these 2.0 percent solids solutions and diluting them to 2000 ppm solids using 2.5 percent tetramethylammonium hydroxide (TMAH). Surface tensions were then measured as described above and are reported in Table 3 (below).

TABLE 3

| | | | SURFACE |
|---|---|---|---|
| | | | TENSION AT |
| | | WEIGHT | 2000 PPM IN |
| | STOCK | PERCENT | 2.5 PERCENT |
| | SOLUTION | FBSEE | BY WEIGHT |
| EXAMPLE | III, g | (solids) | TMAH |
| COMPARATIVE | 0 | 0 | 53.39 |
| EXAMPLE D | | | |
| 16 | 4 | 13.7 | 31.23 |
| 17 | 7.05 | 22 | 27.36 |

All patents and publications referred to herein are hereby incorporated by reference in their entirety. All numerical ranges in the specification and claims are inclusive of their endpoints unless otherwise indicated. Various modifications and alterations of this disclosure may be made by those skilled in the art without departing from the scope and spirit of this disclosure, and it should be understood that this disclosure is not to be unduly limited to the illustrative embodiments set forth herein.

What is claimed is:

1. A method of making a composition, the method comprising:
independently providing a first component comprising a first compound, and a second component comprising a second compound; and
combining the first component and the second component,
wherein:
a) the first compound is represented by 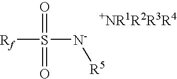
wherein
R_{f} represents a perfluoroalkyl group having from 1 to 12 carbon atoms;
R¹, R², R³, and R⁴ each independently represent H or an alkyl group having from 1 to 6 carbon atoms; and
R⁵ represents H, an alkyl group having from 1 to 6 carbon atoms, or a hydroxyalkyl group having from 1 to 6 carbon atoms; and
b) the second compound is represented by 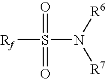
wherein
R⁶ and R⁷ each independently represent an alkyl group having from 1 to 6 carbon atoms, or a hydroxyalkyl group having from 1 to 6 carbon atoms.

2. The method of claim 1, wherein at least one of the first component or the second component further comprises water.

3. The method of claim 1, further comprising adding water to the composition.

4. The method of claim 1, wherein a relative mole ratio the first compound to the second compound is in a range of from 1:1 to 20:1.

5. The method of claim 1, wherein all of R¹, R², R³, and R⁴ are H or all of R¹, R², R³, and R⁴ are methyl.

6. The method of claim 1, wherein R⁵, R⁶, and R⁷ are hydroxyalkyl groups.

7. The method of claim 1, wherein R⁶ and R⁷ are the same and all of R¹, R², R³, and R⁴ are methyl.

8. The method of claim 1, wherein R_{f} has from 3 to 5 carbon atoms.

9. The method of claim 1, further comprising adding a third compound to the composition, the third compound represented by

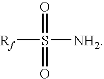

10. The method of claim 1, wherein the first compound is selected from the groups consisting of ammonium N-perfluorobutanesulfonamide, ammonium N-perfluoro-(2-hydroxyethyl)perfluorobutanesulfonamide, tetramethylammonium N-perfluorobutanesulfonamide, and tetramethylammonium N-perfluoro-(2-hydroxyethyl)perfluorobutanesulfonamide.

11. The method of claim 10, wherein the second compound is selected from the groups consisting of N,N-bis(2-hydroxyethyl)perfluorobutanesulfonamide and N-methyl-N-(2-hydroxyethyl)perfluorobutanesulfonamide.

12. The method of claim 1, wherein the second compound is selected from the groups consisting of N,N-bis(2-hydroxyethyl)perfluorobutanesulfonamide and N-methyl-N-(2-hydroxyethyl)perfluorobutanesulfonamide.

13. An aqueous composition comprising:
water;
a first compound represented by 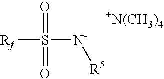
wherein
R_{f} represents a perfluoroalkyl group having from 1 to 12 carbon atoms; and
R⁵ represents H, an alkyl group having from 1 to 6 carbon atoms, or a hydroxyalkyl group having from 1 to 6 carbon atoms; and
a second compound represented by 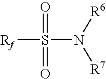
wherein
R⁶ and R⁷ each independently represent an alkyl group having from 1 to 6 carbon atoms, or a hydroxyalkyl group having from 1 to 6 carbon atoms, and
wherein the aqueous composition is essentially free of halide ions.

14. The aqueous composition of claim 13, wherein a relative mole ratio of the first compound to the second compound is in a range of from 1:1 to 20:1

15. The aqueous composition of claim 13, wherein the first compound and the second compound collectively comprise at least 5 percent by weight of the aqueous composition.

16. The aqueous composition of claim 13, wherein the first compound and the second compound are collectively present in the aqueous composition in an amount of from 100 to 10,000 parts per million by weight of the aqueous composition.

17. The aqueous composition of claim 13, wherein each of R⁵, R⁶, and R⁷ are 2-hydroxyethyl groups.

18. The aqueous composition of claim 13, wherein the first compound is selected from the groups consisting of ammonium N-perfluorobutanesulfonamide, ammonium N-perfluoro-(2-hydroxyethyl)perfluorobutanesulfonamide, tetramethylammonium N-perfluorobutanesulfonamide, and tetramethylammonium N-perfluoro-(2-hydroxyethyl)perfluorobutanesulfonamide.

19. The aqueous composition of claim 18, wherein the second compound is selected from the groups consisting of N,N-bis(2-hydroxyethyl)perfluorobutanesulfonamide and N-methyl-N-(2-hydroxyethyl)perfluorobutanesulfonamide.

20. The aqueous composition of claim 13, wherein the second compound is selected from the groups consisting of N,N-bis(2-hydroxyethyl)perfluorobutanesulfonamide and N-methyl-N-(2-hydroxyethyl)perfluorobutanesulfonamide.
